(19) United States
(12) Patent Application Publication
(10) Pub. No.: US 2013/0317960 A1
(43) Pub. Date: Nov. 28, 2013

(54) METHOD FOR THE PROCESSING OF BANKNOTES

(71) Applicants: Norbert Holl, Germering (DE); Jürgen Schmitz, Holzkirchen (DE); Dieter Stein, Holzkirchen (DE)

(72) Inventors: Norbert Holl, Germering (DE); Jürgen Schmitz, Holzkirchen (DE); Dieter Stein, Holzkirchen (DE)

(73) Assignee: Giesecke & Devrient GmbH, Muenchen (DE)

(21) Appl. No.: 13/821,692

(22) PCT Filed: Sep. 15, 2011
(86) PCT No.: PCT/EP2011/004643

§ 371 Date: May 20, 2013

(30) Foreign Application Priority Data
Sep. 17, 2010 (DE) 10 2010 045 879.1

(51) Int. Cl. G06Q 40/00

(52) U.S. Cl. CPC G06Q 40/00
USPC 705/35

(57) ABSTRACT

A method for the processing of bank notes wherein serial numbers of the bank notes to be processed are ascertained and compared with stored serial numbers in order to control the processing of the bank notes, having a specification of several classes which respectively characterize at least one property of bank notes, an association of at least one of the classes with one or several serial numbers in order to associate at least one property with the bank note provided with the respective serial number, a storage of the respective serial number as well as of the associated class or classes, and a control of the processing of the bank notes by means of the stored classes associated with the respective serial numbers.

This invention relates to a method for the processing of bank notes.

For the processing of bank notes it is provided that the bank notes are input to an input region as loose stacks and singled by a singler. The individual bank notes are transferred by the singler to a transport system and supplied to processing. Conventional forms of processing for bank notes are acceptance, checking and recognition of the bank notes by means of sensors, there being ascertained the authenticity, type (currency, denomination), condition (soiling, damage), etc. On the basis of the results of checking and recognition, the bank notes are subsequently e.g. sorted, stacked, bundled, destroyed, etc.

For checking the authenticity of the bank notes, in particular serial numbers of the bank notes are also taken into consideration. Forged bank notes are frequently copied, so that the forged bank notes frequently have one or only a few serial numbers. When forgeries are recognized, the serial number is captured and stored. Upon a later check of bank notes their serial numbers are captured and compared with the stored serial numbers of the known forgeries. If a match is ascertained, the checked bank note is a forgery.

On these premises, it is the object of the present invention to state a method for the processing of bank notes that makes it possible without elaborate measures to control the processing of the bank notes flexibly by means of their serial numbers.

The accomplishment of this object results from the features of the independent claim. Developments are the subject matter of the subclaims.

The invention starts out from a method for the processing of bank notes wherein serial numbers of the bank notes to be processed are ascertained and compared with stored serial numbers in order to control the processing of the bank notes, having a specification of several classes which respectively characterize at least one property of bank notes, an association of at least one of the classes with one or several serial numbers in order to associate at least one property with the bank note provided with the respective serial number, a storage of the respective serial number as well as of the associated class or classes, and a control of the processing of the bank notes by means of the stored classes associated with the respective serial numbers.

The advantage of the solution according to the invention consists in the fact that information required for the processing of bank notes can be associated with certain bank notes via their serial number freely and in a manner that is simply adaptable to the requirements to be respectively heeded for the processing of the bank notes. It is thus possible to influence the processing of bank notes for every need flexibly and simply in the desired fashion.

In advantageous developments it is provided to define permissible ranges for the respective serial numbers and/or the classes, in particular by the employment of placeholders.

This allows a further flexibilization and simplification of the processing of bank notes, because it allows the consideration of a multiplicity of known serial numbers and/or classes in a simple manner.

Further embodiments and advantages of the invention will be explained hereinafter with reference to the figures as well as their description.

There are shown

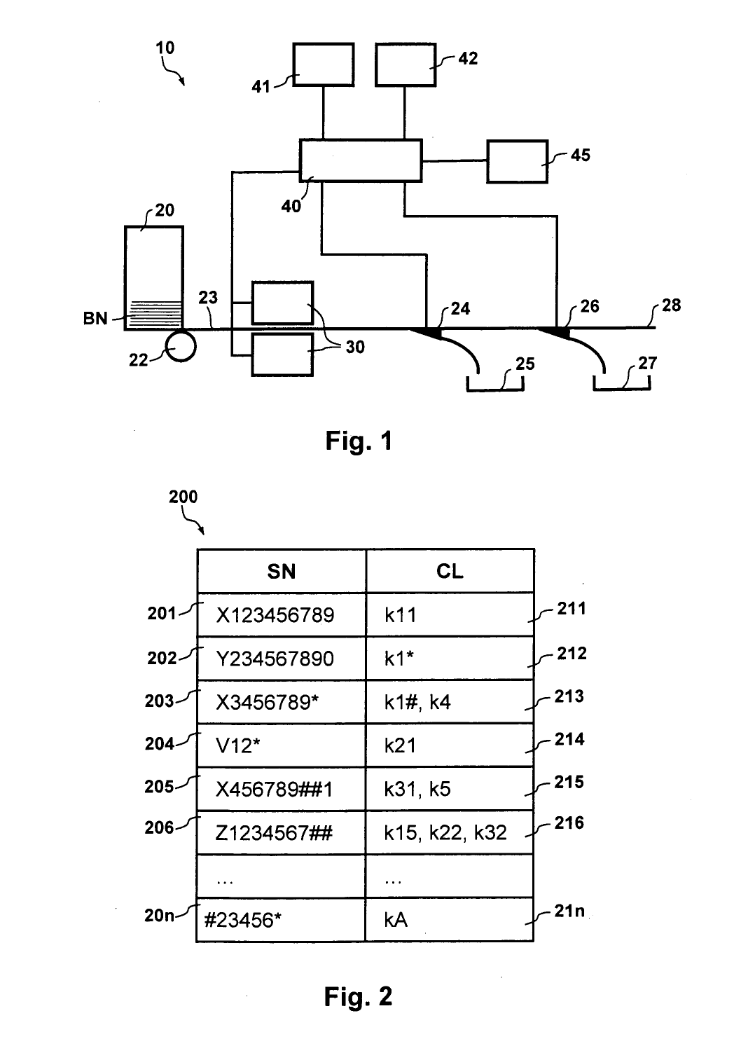

FIG. 1 an exemplary embodiment of a bank-note processing machine,

FIG. 2 an embodiment of a table for processing bank notes by means of serial numbers, and

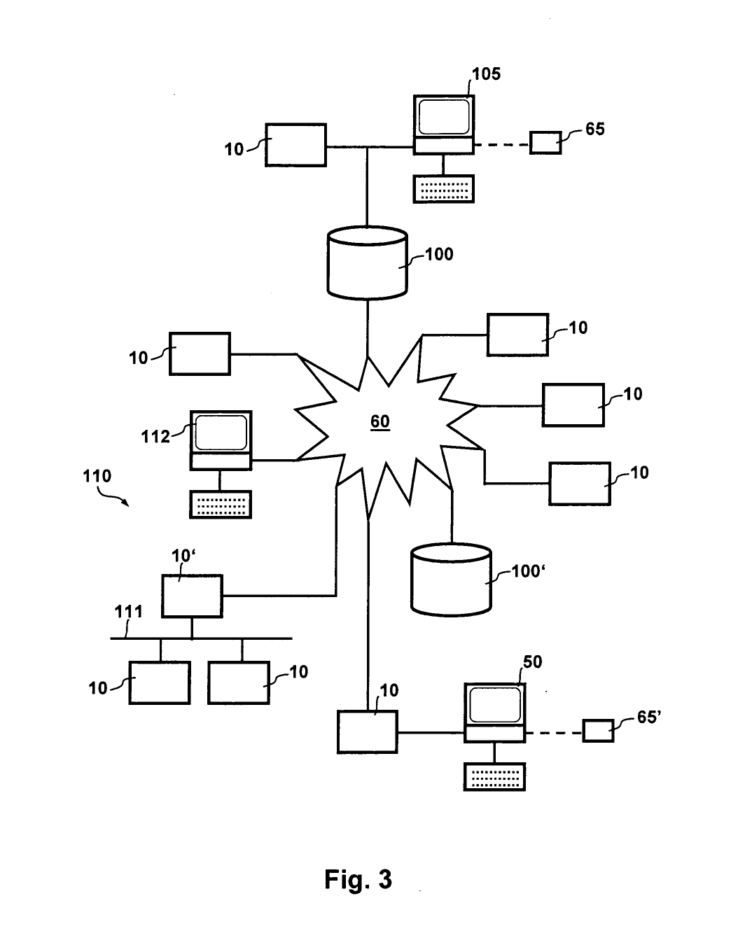

FIG. 3 an exemplary embodiment of a network of bank-note processing machines, as represented in FIG. 1.

FIG. 1 shows a schematic representation of a schematic structure of an exemplary embodiment of a bank-note processing machine 10 which is suitable for the processing of bank notes, in particular for checking and sorting.

The bank-note processing machine 10 has an input pocket 20 for the inputting of bank notes BN to be processed, which is engaged by a singler 22. The singler 22 grasps one of the bank notes BN to be processed at a time and delivers the individual bank note to a transport system 23, which transports the individual bank note through a sensor device 30. In the sensor device 30 there are captured features of each individual bank note that are relevant for example for the assessment of the authenticity, the type (currency, denomination), the condition, etc., of the bank note. Such features can be captured for example mechanically, acoustically, optically, electrically and/or magnetically. Known authentication features comprise for example printing inks having special optical and/or magnetic properties, metallic or magnetic security threads, the employment of brightener-free bank-note paper, information contained in an electrical circuit, etc. The type of the bank note is specified e.g. by its size, print pattern, colors, etc., whereas the condition of the bank note can be derived for example from the optical appearance (soiling). Furthermore, the sensor device 30 captures an image or partial regions of the image of the respective bank note. The image, or at least a partial region of the image, contains a serial number of the respective bank note. Images or partial regions of the image can be captured from one or from both sides of the respective bank note. The features captured by the sensor device 30 and images or corresponding data of the sensor device 30 are delivered to a control device 40.

By the control device 40 the data of the captured features are compared with comparison data which enable the recognition of authentic or forged and/or suspect bank notes, the type of the bank notes, the condition of the bank notes, etc. The comparison data as well as programs required for the operation of the bank-note processing machine 10 are present as software and stored in the control device 40 or a non-volatile memory 41 associated with the control device 40. The non-volatile memory 41 can be formed e.g. by an EEPROM memory, a flash memory or a fixed-disk memory. Further, there can be connected to the control device 40 a working memory (not represented) which is employed by the control device 40 for the execution of the software. Moreover, the images or partial regions of the images of the respective bank note are evaluated by the control device 40 in order to derive the serial number of the respective bank note as numerical or alphanumeric characters which can be stored in the non-volatile memory 41. The serial number contained in the images or partial regions of the images is derived e.g. by an OCR method. For checking the respective bank note, the control device 40 compares the derived serial numbers with serial numbers stored e.g. in the non-volatile memory 41. The data or serial numbers employed for the comparison can be stored for example as a table.

On the basis of the check of the respective bank note carried out by the control device 40, gates 24, 26 arranged in the transport system 23 are controlled in order to deposit for example forged and/or suspect bank notes in an output pocket 25, whereas bank notes classified as authentic can be deposited in another output pocket 27. The transport system 23 can be continued therebeyond, so that the bank notes can be supplied to a further processing 28, e.g. to further output pockets, a safe or cassettes in which the bank notes can be safely kept and transported, to a shredder, etc.

For control of the bank-note processing machine 10 by an operating person, an input/output device 45 is connected to the control device 40 to enable the selection of certain processing modes, for example, or to inform the operating person about the processing of the bank notes BN. For this purpose, a keyboard and a display can be present. Likewise, it is possible that a touch-sensitive display (touch screen) is employed or an arbitrary combination of the stated means. Further, a printer can be provided to enable the printing out of e.g. accounting data of bank notes that were processed with the bank-note processing machine 11. Further, the input/output device 45 can have a card reader which is suitable for reading cards with a magnetic stripe and/or chip. Such cards can be employed for example for identifying the person operating the bank-note processing machine 11, in order to state for example a certain account that is to be credited with the total amount of the bank notes to be processed. It can also be provided that the operating person must additionally enter a secret password to be able to perform the identification. Additionally, the bank-note processing machine 10 can be connected to a computer 50 (FIG. 3) which serves an operating person for controlling the bank-note processing machine 10.

Further, there can be present an interface 42 which allows connection to a network for communication purposes. For this purpose, the interface 42 can be configured e.g. as a modem, network connection, Internet connection, etc.

Besides the described bank-note processing machine 10 which is suitable in particular for checking and sorting, there can also be employed all other kinds of bank-note processing machines having sensors that allow an ascertainment of serial numbers. This may in particular also be an automated teller for depositing bank notes.

Besides the described ascertainment of serial numbers by derivation from an image or partial image of bank notes, any other possible ascertainment of the serial numbers is suitable, e.g. the reading out of a serial number from a circuit of the bank notes, for example an RFID circuit.

As mentioned above, the bank-note serial numbers ascertained for the check are compared with known serial numbers stored in the non-volatile memory 41 of the bank-note processing machine 10. Data about the known serial numbers SN are stored for example in a list or table 200 as represented in FIG. 2, with each known serial number SN having one or several classes or categories CL associated therewith which describe certain properties of the bank notes. The further processing can be controlled in accordance with the associated class or classes CL.

For example, a first serial number 201 has a class 211 associated therewith. The class 211 is designated for example as “k11”. The class “k11” means here that the associated serial number “X123456789”, or the bank note denoted thereby, has a very good overall condition which for example allows the bank note to be put back into circulation and a money dispensing machine to be employed for this purpose. Quite generally, the class “k1x” can describe the condition of the bank note. The class “k11” means for example, as described above, a very good overall condition of the bank note. A class “k12” can describe a good overall condition, i.e. bank notes that are fit for circulation but do not meet the high requirements for being dispensed by a money dispensing machine A class “k13” can describe an overall condition with slight traces of usage, i.e. bank notes that are e.g. soiled. A class “k14” can describe an overall condition with stronger traces of usage, i.e. bank notes that are e.g. soiled and have folds or dog's-ears. A class “k15” can describe an overall condition with strong traces of usage, i.e. bank notes that have e.g. defects such as tears or that have parts missing. Via a corresponding scaling it is possible to specify and describe further gradated properties of the bank note. Besides the described gradation by means of two digits “k11” it is also possible to employ only one digit, e.g. “k1”, or more than two digits, e.g. “k111”. Besides the employment of digits there can also be employed other characters, e.g. alphanumeric characters.

Upon the check of bank notes in the bank-note processing machine 10, the ascertained serial numbers of the bank notes are compared by the control device 40 with the serial numbers SN contained in the table 200. If for example the serial number 201 is recognized upon the comparison, the associated class 211 can be employed for the further processing. For example, because the condition assigned to the bank note corresponds to the class “k11”, i.e. is very good, the bank note is transported into the output pocket 27 and deposited there under the control of the control device 40.

For example, a second serial number 202 has a class 212 associated therewith. The class 212 is designated for example as “k1*”. The class “k1*” means here that the associated serial number X234567890, or the bank note denoted thereby, can have an arbitrary condition. In accordance with the above explanation, the condition of the bank note can be very good “k11”, good “k12”, less gut “k13”, etc. This means that using corresponding characters, so-called placeholders or wild cards, e.g. the character “*”, a serial number SN can have arbitrary classes CL or ranges of classes CL associated therewith. The character “*” as a placeholder can have the meaning that the character “*” can be replaced by no, or any number of, digits or alphanumeric characters.

Upon the check of bank notes in the bank-note processing machine 10, the ascertained serial numbers of the bank notes are compared by the control device 40 with the serial numbers SN contained in the table 200. If for example the serial number 202 is recognized upon the comparison, the associated class 212 can be employed for the further processing. For example, because the condition assigned to the bank note corresponds to the class “k1*”, i.e. can have an arbitrary, not specifically defined condition, the bank note is rated by the control device 40, for which purpose the control device 40 evaluates the above-described features of the bank note that were captured by the sensor device 30. The further processing can then be effected in dependence on this rating. It can also be provided that the information about the condition of the respective bank note that is derived from the signals or data of the sensor device 30 by the control device 40 is associated with its serial number. In the present example, the class 212 of the serial number 202 then has for example the condition “k12” associated therewith, instead of the not specifically defined condition “k1*”, if the check yielded that the bank note has a good condition.

For example, a third serial number 203 has a class 213 associated therewith. The class 213 is designated for example as “k1#, k4”. This means that the serial number “X3456789*” has the class “k1#” and the class “k4” associated therewith. The class “k1#” can relate here to the above-described characterization of the condition of the bank note. The character “#” is used as a placeholder and means for example that the character “#” can be replaced by one, or no, digit or one, or no, alphanumeric character. The class “k4” can denote for example bank notes that are part of stolen or ransom money. All bank notes having a serial number that begins with “X3456789” are accordingly recognized as bank notes that have been stolen or extorted because the serial number 203 “X3456789*” contains a character “*” which is employed as a placeholder. In accordance with the above explanation, the character “*” can stand for no, or any number of, digits or alphanumeric characters.

Upon the check of bank notes in the bank-note processing machine 10, the ascertained serial numbers of the bank notes are compared by the control device 40 with the serial numbers SN contained in the table 200. If there is recognized upon the comparison for example the serial number 203, i.e. a serial number beginning with the character string “X3456789”, the associated class 213 can be employed for the further processing. For example, because the bank note is denoted as stolen or ransom money by the class “k4”, the bank note is transported via the continuation 28 of the transport system 23 to a special output pocket (not represented). Additionally, the control device 40 can produce a warning signal and display it for example on the input/output device 45. It is also possible to stop processing upon the recognition of stolen or ransom money. Additionally, the serial number 203 has the class “k1#” assigned thereto, i.e. it can have an arbitrary, not specifically defined condition.

For example, a fourth serial number 204 has a class 214 associated therewith. The class 214 is designated for example as “k21”. This means that the serial number “V12*” has the class “k21” associated therewith. The class “k21” can describe a certain country, a printing facility or a place of origin of the bank notes. All bank notes having a serial number that begins with “V 12” are accordingly recognized as bank notes coming from the certain country, printing facility or place of origin. In accordance with the above explanation, the character “*” can stand for no, or any number of, digits or alphanumeric characters.

Upon the check of bank notes in the bank-note processing machine 10, the ascertained serial numbers of the bank notes are compared by the control device 40 with the serial numbers SN contained in the table 200. If there is recognized upon the comparison for example the serial number 204, i.e. a serial number beginning with the character string “V12”, the associated class 214 can be employed for the further processing. For example, because the bank note is denoted by the class “k21” as coming from a certain place, it is transported into the output pocket 27, into which for example only bank notes coming from the certain country are transported.

For example, a fifth serial number 205 has a class 215 associated therewith. The class 215 is designated for example as “k31” and “k5”. This means that the classes “k31” and “k5” are associated with all serial numbers “X456789##1”, i.e. with all bank notes whose serial number corresponds to the known serial number 205, whereby the second-last and third-last places of the serial number can be arbitrary. The class “k31” can describe a certain series or emission of the corresponding bank note, i.e. a certain issue of a bank note of a certain currency and denomination. The class “k5” can mean that accordingly denoted bank notes are forgeries. All bank notes having a serial number that matches “X456789##1” are accordingly recognized as bank notes that are forged and are for example the forgery of a bank note from a certain series or emission.

Upon the check of bank notes in the bank-note processing machine 10, the ascertained serial numbers of the bank notes are compared by the control device 40 with the serial numbers SN contained in the table 200. If there is recognized upon the comparison for example the serial number 205, i.e. a serial number that matches “X456789##1”, the associated class 215 can be employed for the further processing. For example, because the bank note is denoted by the class “k5” as a forgery, it is transported via the continuation 28 of the transport system 23 to a special output pocket (not represented). Additionally, the control device 40 can produce a warning signal and display it for example on the input/output device 45. Likewise, the processing can be stopped when a forgery is recognized.

For example, a sixth serial number 206 has a class 216 associated therewith. The class 216 is designated for example as “k15”, “k22” and “k32”. This means that the classes “k15”, “k22” and “k32” are associated with all serial numbers “Z1234567##”, i.e. with all bank notes whose serial number corresponds to the known serial number 206, whereby the last and second-last places of the serial number can be arbitrary. The class “k15” can describe an overall condition with strong traces of usage, i.e. bank notes that have e.g. defects such as tears or that have parts missing. The class “k22” can describe a certain country, printing facility or place of origin of the bank notes. The class “k32” can describe a certain series or emission of the corresponding bank note. All bank notes having a serial number that matches “Z1234567##” are accordingly recognized as bank notes having a poor overall condition, coming from a certain place and belonging to a certain series or emission.

Upon the check of bank notes in the bank-note processing machine 10, the ascertained serial numbers of the bank notes are compared by the control device 40 with the serial numbers SN contained in the table 200. If there is recognized upon the comparison for example the serial number 206, i.e. a serial number that matches “X1234567##”, the associated class 216 can be employed for the further processing.

For example, because the bank note is denoted by the class “k15” as a bank note with strong traces of usage, it is transported via the continuation 28 of the transport system 23 to the shredder and destroyed.

The associated classes CL can also have certain relations. For example, the classes “k15”, “k22” and “k32” associated with the sixth serial number 206 can have such a relation. For example, the classes “k22” and “k32” have the relation that they come from a certain place “k22”, i.e. belong to a country issuing the bank note, and to a certain series or emission “k32” of the bank notes of this country. Likewise, the classes “k15” and “k22” can have a relation. Since it is known at what time a certain series or emission “k32” was issued, it can be assumed after expiry of a certain time that corresponding bank notes have a poor overall condition.

For example, an nth serial number 20n has a class 21n associated therewith. The class 21n is designated for example as “kA”. This means that the class “kA” is associated with all serial numbers “#23456*”, i.e. with all bank notes whose serial number corresponds to the known serial number 20n, whereby the second to sixth positions of the serial number correspond to “23456”, whereas the first place and all places after the sixth place of the serial number can be arbitrary. The class “kA” can be a class that is freely defined, for example by the operating person using the input/output device 45. The class “kA” can consist of an arbitrary combination of available classes, e.g. “kA”=(“k11” “k2” “k3”). However, it is also possible that the operating person assigns further properties. These further properties can also be combined with the available classes. For example, the class “k4”, which designates stolen or ransom money, can have associated therewith the information of which police station is to be informed that the bank note has appeared.

Upon the check of bank notes in the bank-note processing machine 10, the ascertained serial numbers of the bank notes are compared by the control device 40 with the serial numbers SN contained in the table 200. If there is recognized upon the comparison for example the serial number 20n, i.e. a serial number that matches “#23456*”, the further processing is effected in accordance with the classes or properties associated with the class “kA”.

FIG. 3 shows a schematic representation of a schematic structure of an exemplary embodiment of a network for the connection of bank-note processing machines, as represented in FIG. 1.

There can be connected to the network 60 one or several bank-note processing machines 10 whose structure is described more precisely above. Via the network 60, e.g. a wire-based and/or wireless telephone network, a local network, the Internet, etc., the bank-note processing machines 10 are connected to a central device 100 which consists e.g. of a data memory or a database, i.e. has e.g. a computer 105 with a storage medium 100. The network 60 can also be realized in a different way, e.g. as a wireless network or as a network that provides data via the electricity supply system.

For relieving the central device 100, it can be provided that further central devices 100′, or at least data memories, are connected to the network 60. The further central devices 100′ can be located for example in different countries in order to distribute, and thus reduce, the load on the central device 100 through requests from bank-note processing machines 10. This enables a faster processing of the requests. Additionally, there can be offered in the respective countries e.g. a communication in the respective national language, which results in a simplification. Normally the further central devices 100′ are formed by data memories that correspond to the data memory of the central device 100. The data or tables of the data memories of the further central devices 100′ are then transferred at certain times to the central device 100, which can synchronize and consolidate all the data or tables. The thus updated data or tables can thereafter be distributed to all further central devices 100′, which make the updated data or tables available to the bank-note processing machines 10.

The bank-note processing machines 10 can be connected to the central device 100 via the network 60 individually, but it is also possible for several bank-note processing machines 10, which are interconnected directly or via a data bus or a local network 111, to be connected to the central device 100 via a bank-note processing machine 10′ and the network 60. The bank-note processing machine 10′ connected to the network 60 then performs the data exchange or the communication with the central device 100. The data or tables coming from the central device 100 are made available to the other bank-note processing machines 10 via the local network 111. In the same way, data or tables coming from the other bank-note processing machines 10 are passed via the local network 111 to the bank-note processing machine 10′, in order for the latter to be able to relay the data or tables to the central device 100. When the bank-note processing machines 11 are directly interconnected, a cascade-like connection can be provided. This enables a particularly fast relaying of the data or tables, because the relaying can be effected in avalanche-like fashion in the cascade. The local network 111 can also be realized as a wireless network or as a network that makes data available via the electricity supply system.

The bank-note processing machines 10, 10′ can be associated with a certain operator 110, for example a certain bank, security transport company, etc. For monitoring the individual bank-note processing machines 10, 10′ the operator 110 can have a monitoring unit 112, e.g. a computer. The computer 112 is connected to the network 60 and to the central device 100 via a corresponding interface. This enables the operator 110 to employ the computer 112 also for effecting an exchange of data or tables between central device 100 and bank-note processing machines 10, 10′, or for processing tables. Likewise, it is possible that the computer 112 is connected directly to the local network 111 or to the individual bank-note processing machines 10, 10′. It is evident that an operator 110 can operate different bank-note processing machines 10 which are connected to the central device 100 via a single bank-note processing machine 10′ and the network 60 in the described fashion. Likewise, the individual bank-note processing machines 10, 10′ of the operator 110 can be connected to the central device 100 via the network 60 directly. It is also possible that the local network 111 is coupled to the network 60 via a corresponding interface.

A bank-note processing machine 10 can also be present in the central device 100 in order to process certain bank notes present only in the central device 100, e.g. to capture the serial numbers of said certain bank notes or to process data or tables. Moreover, the computer 105 of the central device 100 can be employed to input or process corresponding data. The same holds for the computer 50 of the bank-note processing machine 10. On the bank-note processing machine 10 a processing of the data or tables can also be effected by means of the input/output device 45. For this purpose, a special operating mode can be provided for example. Upon the processing of the data or tables, existing serial numbers and associated classes can be deleted or the associated classes changed. Likewise, new serial numbers with appurtenant classes can be included.

Hitherto it was assumed that the associations of serial numbers SN and classes CL are transmitted to the bank-note processing machine or machines 10 via a network 60. However, arbitrary other kinds of transmission are suitable, for example by means of a data carrier 65, e.g. an optical memory or a solid-state memory, whose data can be read 65′ by the bank-note processing machine or machines 10. Likewise, it is possible not to perform the exchange of the tables via the central device. The tables can for example also be transferred from a bank-note processing machine 10 to one or several other bank-note processing machines 10.

Hitherto the association of serial numbers SN and classes CL was described on the basis of a list or table. However, it is evident that any other way of associating one or several classes with the known serial numbers SN can be employed. For example, the serial numbers SN and classes CL can be contained in a script file which is created e.g. in the XML format.

Likewise, it is possible to employ several lists or tables instead of one list or table. Said several tables can be produced individually or be generated from an overall table. For example, there can be employed for generation the class CL in order to divide e.g. known serial numbers SN into different tables. If a distinction is made e.g. according to the classes “k21” and “k22”, two tables can be generated for known serial numbers SN coming from certain countries.

Upon the processing of bank notes BN it is possible to compare the known serial numbers SN of all employed lists or tables with the serial number ascertained upon processing, but there can also be employed only certain lists or tables. For example, there can be employed upon processing only one of the tables generated as described above, e.g. the table containing the known serial numbers SN having the country class “k21” associated therewith, because e.g. only bank notes of this country's currency are being processed.

The production or generation and selection of the tables can be effected for example by means of the input/output device 45 or the computer 50. For this purpose, special operating modes can be provided, as described above. Likewise, said production or generation is possible at another place, e.g. the central device 100 or 100′.

1-10. (canceled)

11. A method for the processing of bank notes wherein serial numbers of the bank notes to be processed are ascertained and compared with stored serial numbers in order to control the processing of the bank notes, comprising the steps:
specifying several classes which respectively characterize at least one property of bank notes,
associating at least one of the classes with one or several serial numbers in order to associate at least one property with the bank note provided with the respective serial number,
storing the respective serial number and the associated class or classes, and controlling the processing of the bank notes using the stored classes associated with the respective serial numbers.

12. The method according to claim 11, wherein there are produced one or several tables in which serial numbers respectively have at least one class associated therewith.

13. The method according to claim 12, wherein one or several of the tables are selected upon processing, and taken into consideration for the control of the processing.

14. The method according to claim 11, wherein further properties of the bank notes are captured of a sensor device upon the processing of the bank notes, and employed to control the processing of the bank notes.

15. The method according to claim 14, wherein the further properties of the bank notes that are captured by the sensor device are associated with the serial numbers of the respective bank notes as corresponding classes.

16. The method according to claim 11, wherein ranges are defined for the classes and using placeholders.

17. The method according to claim 11, wherein ranges are defined for the serial numbers and using placeholders.

18. The method according to claim 11, wherein the association of one or several classes with one or several serial numbers that has been performed for the processing of bank notes at a certain place is transferred to one or several other places for the processing of bank notes at said one or several other places.

19. The method according to claim 11, wherein the association of one or several classes with one or several serial numbers is effected in a script file.

20. A method of processing bank notes in a bank-note processing machine using the method recited in claim 11.
